(19) United States
(12) Patent Application Publication
(10) Pub. No.: US 2023/0210136 A1
(43) Pub. Date: Jul. 6, 2023

(54) NO FLOUR NO FAT ADDED PROTEIN NOODLE AND PROTEIN IN SPHERE AND OVAL SHAPE AND PROCESS

(71) Applicant: KHAENG RANG TOOK WAN CO., LTD., Bangkok (TH)

(72) Inventor: Umaporn BURANASUKSOMBAT, Bangkok (TH)

(73) Assignee: KHAENG RANG TOOK WAN CO., LTD., Bangkok (TH)

(21) Appl. No.: 17/999,711

(22) PCT Filed: Sep. 17, 2021
(86) PCT No.: PCT/TH2021/000059

§ 371 Date: Nov. 23, 2022

(30) Foreign Application Priority Data
Sep. 17, 2020 (TH) 2003002298

(51) Int. Cl. A23J 3/26; A23L 33/17; A23L 33/185; A23L 33/19; A23L 29/256; A23J 3/04; A23J 3/16; A23J 3/14; A23J 3/08; A23P 30/20

(52) U.S. Cl. CPC A23J 3/26; A23L 33/17; A23L 33/185; A23L 33/19; A23L 29/256; A23J 3/04; A23J 3/16; A23J 3/14; A23J 3/08; A23P 30/20

(57) ABSTRACT

This invention is related to fat-free, starch-free protein food that can be processed into noodles, spherical and rice-similar shapes, which consist of 2 parts: the first part are boiled water, egg white powder and/or soy protein, and/or whey protein, and/or pea protein, and/or brown rice protein, and sodium alginate; and the second part are boiled water and calcium chloride concentration as solid gel agent. Fat-free, starch-free protein food in noodles form has 0.5-5 mm diameter, spherical and rice-similar shapes have 2-5 millimetres diameter. Protein foods can be substituted for noodles or glass noodles, or beverages and desserts. This product is a nutritious health food, a good choice for patients and those who want to supplement protein to be able to eat in a variety way and more appetizing.

### FIELDS OF SCIENCE RELATED TO INVENTION

Food science and nutrition in relation to fat-free, starch-free protein food that can be processed into noodles, sphere and rice-similar shapes. (Food science and nutrition related to protein food without starch and fat in the formulation into noodle, sphere and rice-similar shapes).

### BACKGROUND IN THE RELEVANT ARTS OR SCIENCES

Patients with chronic diseases such as kidney disease and cancer need nutrients, especially protein, to repair and restore the body. The amount of protein that should be intake is quite close to normal people, which is between 0.6-0.8 grams per kilogram of body weight per day. For example, a 50 kg patient should receive 30-40 grams of protein per day. For kidney patients after dialysis, an additional 1.2 g of protein per kg of body weight per day is required to replace the loss during dialysis.

When patients have to eat a lot of food continuously every day to get enough protein may cause the patients to feel bored. This will cause the lack of the amount of protein and other nutrients as prescribed. Especially in patients, the body may not recover, or not recover as quickly as it should. And not getting enough protein can negatively affect protein-intensive systems in the body, such as the immune system, blood and hormonal system.

Egg white is a good source of protein. It provides high protein and essential amino acids, 100 grams of egg white provides 22% protein, 26% Vitamin B2, and 29% Selenium of the daily needed values (Per cent daily values), no fat and cholesterol.

Besides, it's easy to find, inexpensive, and easy to digest. So, egg white is an ideal source of protein for patients and those who want to keep their bodies healthy. But eating egg white in the same way, such as boiled eggs, fried eggs, poached eggs, to get enough protein to meet daily needs, must eat in large quantities. It may cause consumers to feel fed up.

Processing egg white into new forms to make it more convenient and appetizing, at present, there are still a few. Most found products contain egg white and various flours are egg white crackers and egg white noodles. Products made from egg white without added starch, are egg white beverages, egg white tubes, and seasoned egg white cups.

In addition to ready-to-eat products, egg white is also processed into powdered egg white, to prolong the shelf life, more convenient transportation, and cheaper. Egg white powder contains 80-90% protein by weight. When mixed with water, it will turn back into egg white. It can be used for cooking as well as fresh egg white.

Besides the egg white, protein powders, such as whey protein or soy protein, are widely used in protein supplementation for both normal persons and patients. Both types are high quality, provide high protein and complete essential amino acids, by providing protein content of 80-90% by weight. They can be easily purchased in the market. Most

of the products are in powder form, and have evolved into food such as protein bars and cookies.

Alginate is polysaccharide (polysaccharide), extracted from the cell wall of brown algae. This long chain molecule contains (1,4)-linked β-D-mannuronate (M) and α-L-guluronate (G) residues. The human body is unable to digest alginate because it does not contain the enzyme that digests alginate. Alginate is hydrocolloid, commonly used in the food industry for thickening, gelling and film forming agents. Alginate has the ability to be gel at low temperatures, and is heat resistant. Alginate or alginic acid salt comes in many forms such as sodium alginate, calcium alginate. When sodium alginate is in calcium chloride solution (CaCl2), sodium ion on this polysaccharide chain is cross-linked with calcium ions. It is in a form called egg box, which looks like a solid gel. Alginate is widely used in processed meat products, fruits, pastas, as an ingredient in noodles, and used in the production of glass noodle (alginate noodle).

Nowadays, glass noodle is very popular, especially among consumers who want to reduce their consumption of starch and fat, glass noodle can be used to replace vermicelli in almost every menu. The main components of the glass noodle are sodium alginate solution (sodium alginate) and calcium chloride solution (calcium chloride). It does not contain carbohydrates and fats. Adding protein-rich food ingredients such as egg whites, soy protein, or whey protein in ingredient formula will make new types of glass noodles better nutritious. And it will make the noodles less stiff, white to light brown color, softer, closer texture to the starch noodles. It can be used to replace noodles and rice noodles beautifully. Besides, ingredients of glass noodles with egg whites and/or soy protein, and/or whey protein as an ingredient, can also be made into round or rice-similar shapes to replace pearls in beverages and desserts. Therefore, it is a good choice for patients and those who want to supplement protein with a variety of foods that are more appetizing.

According to the search, the protein noodle product or spherical and rice-similar protein granules made from egg whites and/or soy protein, and/or whey protein without the addition of starch and fat that can be used in food drinks and desserts, has not yet been found. Development of this product has the desired aim to develop a healthy diet that provides protein, free from starch and fat in the ingredients, which can be consumed frequently in daily life. The protein noodles can be eaten as noodles, which are popular among Thai people. And spherical and rice-similar protein shapes can be applied in popular beverages such as milk tea. It is considered food that benefits patients with chronic diseases such as kidney disease and cancer including those who want to maintain healthy lifestyles.

### THE NATURES AND PURPOSES OF THE INVENTION

The invention involves starch-free, fat-free protein food that can be processed into noodles, spherical and rice-similar forms, which consists of 2 parts: the first part is boiled water, egg white powder and/or soy protein, and/or whey protein, and/or pea protein, and/or brown rice protein and sodium alginate, and the second part including boiled water and concentrated calcium chloride, as a solid gel agent.

Starch-free, fat-free protein food in noodles form has 0.5-5 mm diameter, spherical and rice-similar forms have 2-5 mm diameter. This product was developed from the gelling technique of sodium alginate and calcium chloride. Protein noodles and this spherical and rice-similar shapes protein are different from other protein products in the market. And it adds more value to egg white and protein powders.

The purpose of this invention is to obtain fat-free, starch-free protein food products that can be processed into high protein noodles, spheres and rice-similar shapes as an alternative to supplementing protein nutrition for patients and consumers who want to maintain good health.

### FULL DISCLOSURE OF THE INVENTION

Fat-free, starch-free protein food that can be processed into noodles, spherical and rice-similar shapes according to this invention, consists of two components:

### Part 1

boiled water 50-90% volume by weight
Egg white powder (egg white powder, egg albumin powder) providing 80-90% protein and/or soy protein providing 80-90% protein, and/or whey protein providing 80-90% protein, and/or pea protein providing 80-90% protein, and/or brown rice protein providing 80-90% protein, purchased from egg white powder, soy protein, whey protein, pea protein and brown rice protein suppliers. 9.5-45% volume by weight
Sodium alginate, powder and/or flakes, purchased from sodium alginate supplier. 0.5-5% volume by weight

### Part 2

Boiled water 95-99.9% volume by weight
Calcium chloride, granule and/or flakes, purchased from calcium chloride supplier. 0.1-5% volume by weight

Fat-free, starch-free protein food that can be processed into noodles, spherical and elliptical pellets production process according to this invention consists of:

a) Mix part 1, starting with egg white powder and/or soy protein, and/or whey protein, and/or pea protein, and/or brown rice protein, with sodium alginate in a container.

b) Mix the powder into boiled water that has been left to cool, water temperature 15-60 ° C., mix by hand for 20-40 minutes, or use a mixer for 5-20 minutes. Set aside and leave it for 3-12 hours to make sure the ingredients are completely dissolved. It will be part 1, set aside.

c) Mix part 2 by mixing calcium chloride with boiled water that has been cooled to room temperature between 15-40 ° C., and stir for 2-10 minutes until combined to become a solution of calcium chloride with a concentration of 0.5-3%. The volume of calcium chloride solution or part 2, is 1-3 litres per part 1 of 1 kg.

d) For processing to make noodles, part 1 is put into a noodle injection machine with 1-10 horsepower. There is a pump that sucks the mixture through a hose to the nozzle, and then injects onto part 2 solution to make a long line, size and shape as required.

In the absence of an injection machine, place part 1 in a plastic bottle container with a hole punched on the cap, diameter of the hole is 0.5-5 mm. Squeeze the plastic bottle by hand and let the mixture to be injected as a line onto the part 2 solution into a long line, size and shape as required.

e) For making spherical and rice-similar shapes protein, take part 1 into a plastic bottle with a hole punched on the cap, diameter of the hole is 2-5 millimetres, then drop the mixture onto the second part to the desired round and rice-similar sizes and shapes.

f) Soak the noodles and/or spherical, and/or rice-similar protein food into part 2 for 2-40 minutes, then scoop out and rinse with clean room temperature water 2-3 times.

g) Blanch the noodles and/or spherical, and/or rice-similar protein food in boiling water for 1-10 minutes, then scoop out and rinse with clean, room temperature water. Put in a ready-to-eat container.

This invention is a gelling technique of sodium alginate and calcium chloride by using injecting machine injects mixture of sodium alginate, egg white powder, and/or soy protein, and/or whey protein, and/or pea protein, and/or brown rice protein on calcium chloride solution into a continuous line as needed. Or use hand squeeze and drip to make the mixture look like noodles and/or spherical, and/or rice-similar shapes. The texture of the resulting product can be hardened as needed when increasing the concentration and increasing the duration of immersion in calcium chloride solution.

Describing this invention will be done by giving examples to help make it clearer. And the scope of the invention shall be in accordance with the claims attached to it.

### EXAMPLE 1

### Part 1

boiled water 82.5% volume by weight
Selectable protein from egg white powder, soy protein, whey protein, pea protein, brown rice protein or a mixture of these. 16% volume by weight
Sodium alginate (sodium alginate) 1.5% volume by weight

### Part 2

boiled water 99.5% volume by weight
Calcium chloride (calcium chloride) 0.5% volume by weight

a) Mix the first part by mixing the protein and sodium alginate together in a container.

b) The powder from a) is mixed with boiled water that has been left to cool down to 25 degrees Celsius, and stir by hand for 30 minutes or by a mixer for 10 minutes. Set aside for 6 hours to make sure the ingredients are fully dissolved. This will be part 1, set aside.

c) Mix the second part by mixing calcium chloride with boiled water that has been left to

cool at 25 degrees Celsius. Stir for 5 minutes until it is combined to become a solution

of calcium chloride with 0.5% concentration. The volume of this solution of calcium chloride or part 2, is used 2 litres per 1 kg of part 1.

d) For making noodles, part 1 is inserted into a line injection machine with 1 horsepower. A pump sucks the mixture through a hose to the nozzle and then inject onto the second part of the solution into a long line, size and shape as required.

In the absence of an injection machine, put part 1 in a plastic bottle container with a hole punched on the cap, the diameter of the hole is 1.5 mm. Squeeze the plastic bottle by hand, let the mixture to be injected into a line onto the calcium chloride solution in c) into a long line, size and shape as required.

e) For spherical and rice-similar shapes, put part 1 in a plastic bottle with a hole punched on the cap, the diameter of the hole is 3 millimetres, then drop the mixture onto the second part to the desired round and rice-similar sizes and shapes.

f) Soak the protein food, noodles and/or spherical, and/or rice-similar shapes in the second part for 20 minutes, then scoop out and rinse with clean water at room temperature 2-3 times.

g) Blanch the protein food, noodles and/or spherical, and/or rice-similar shapes in boiling water for 5 minutes, then scoop out and rinse with clean water at room temperature. Put in a ready-to-eat container.

### THE BEST METHOD OF INVENTING

As already mentioned in the full disclosure of the invention section.

What is claimed is:

1. Fat-free, starch-free protein food that can be processed into noodles, spherical and rice-similar shapes, wherein the protein food consists of two ingredients:
part 1 comprising:
boiled water for part 1 with 50-90% volume by weight.
egg white powder and/or soy protein, and/or whey protein, and/or pea protein, and/or brown rice protein with 9.5-45% volume by weight and
sodium alginate with 0.5-5% volume by weight and
part 2 comprising:
boiled water for part 2 with 95-99.9% volume by weight and
calcium chloride with 0.1-5% volume by weight.

2. The fat-free, starch-free protein food according to the claim 1, is noodle shaped with 0.5-5 mm. diameter.

3. The fat-free, starch-free protein food according to the claim 1, is spherical and rice-similar shaped, with 2-5 mm. diameter.

4. Production process of fat-free, starch-free protein food that can be processed into noodles, spherical and rice-similar shapes according to the claim 1, has the following steps:
preparing the part 1 by carrying out the steps of:
a) mixing the egg white powder, and/or the soy protein, and/or the whey protein, and/or the pea protein, and/or the brown rice protein with the sodium alginate in a container, to obtain a powder; and
b) adding the powder from step a) into the boiled water for part 1, that has been left to cool and mixing the powder in the water for part 1 for 20-40 minutes by hand or using a mixer for 5-20 minutes wherein temperature of the water for part 1 is 15-60 degree Celsius, and letting the mixture of the powder and the water for part 1 sit for 3-12 hours making sure the mixture of the powder from step a) is completely dissolved in the water for part 1, thereby forming the part 1, which is set aside;
preparing the part 2 by carrying out the steps of:
c) mixing the calcium chloride with boiled water for part 2, that has been left to cool to room temperature between 15-40 degrees Celsius and stirring for 2-10 minutes until the calcium chloride is combined with the boiled water for part 2 to become a solution of calcium chloride with a concentration of 0.5-3%, wherein volume of the calcium chloride solution or part 2 is 1-3 litres per 1 kg of part 1;
d) inserting the part 1 into a line injection machine with power from 1-10 horsepower, wherein a pump is provided for sucking the mixture of part 1 through a hose to a nozzle and then injecting onto the part 2 solution to make a long line, size and shape as required, wherein, in the absence of the injection machine, placing the part 1 in a plastic bottle container with a hole punched on a cap of the plastic bottle container, and squeezing the plastic bottle by hand thereby letting the mixture to be injected as a line onto the calcium chloride solution in item c) to be a long line, size and shape as required, wherein the diameter of the hole is 0.5-5 mm, for making the protein food look like noodle shaped;
e) placing the part 1 in a second plastic bottle with a second hole punched on a diameter of the second plastic bottle cap with 2-5 millimetres diameter, then dropping the mixture onto the second part 2 to a desired round and rice-similar sizes and shapes, for making the protein food look spherical and rice similar shaped;
f) soaking the protein food, noodles and/or spherical, and/or rice-similar shapes into the part 2 for 2-40 minutes, then scooping out and rinsing with clean, room temperature water 2-3 times; and
g) blanching the protein food, noodles and/or spherical, and/or rice-similar shapes in boiling water for 1-10 minutes, then scooping out and rinsing with clean, room temperature water, and then putting in a ready-to-eat container.
